(19) United States
(12) Patent Application Publication
(10) Pub. No.: US 2005/0223565 A1
(43) Pub. Date: Oct. 13, 2005

(54) Jagged edged hairdressing scissors

(76) Inventor: Judith Ann Rutovic, Muncie, IN (US)

Correspondence Address: Law Offices of Thomas J. Schab;Attn: Thomas J. Schab, Esq., 247 Ruth St., Calumet City, IL, 60409, US

(21) Appl. No.: 10/821,077

(22) Filed: Apr. 8, 2004

(51) Int. Cl. B26B 19/22

(52) U.S. Cl. 30/195; 30/230

(57) ABSTRACT

Hairdressing scissors include a pair of identical scissor elements, wherein a first scissors element has a plurality of teeth that alternate between a tall tooth and a short tooth, each tooth having a front and a rear shearing face. The second scissors element includes a plurality of notches formed therein, with the teeth on the first scissors element complimentarily meshed within the span of the notches when the two elements are closed. When hair to be cut is introduced between the elements, the shearing faces cut the hair in a series of point cuts that correspond with the locations of the teeth, leaving the cut hair with varying short and long lengths that are accomplished with only one cutting action of the scissors, rather than with a series of point cuts that would have had to have been performed with conventional hairdressing scissors. The variations in the cut lengths allow the longer hairs to laterally move underneath the shorter lengths of hair, thus providing more movement of the hair, which corresponds to a more lively and lived-in appearance.

### BACKGROUND OF THE INVENTION

1. Field of the Invention

The present invention relates to a pair of hairdressing scissors that are configured to cut the hair of a patron with a series of multi-leveled point cuts at the ends of the hair strands, rather than the continuous blunt cut that is provided with conventional hairdressing scissors.

2. Discussion of the Prior Art

Heretofore, one of the greatest limitations associated with conventional straight-edged hairdressing scissors is that the design of the cutting blade limits how the hair can be cut. Straight-edged scissors inherently dictate that the hair entrapped between the blades will be cut along a continuum with a resultant continuous, blunt edge. In other words, all hair strands placed between the blades will be cut at exactly the same length relative to each other, leaving the hair with a rather lifeless or staid look. One such hair style that exemplifies this condition is the “bob” hair cut, where the hair is cut such that all the hair strand ends are at the same length, relative to one another.

With that in mind, hair stylists are continuously creating new hair styles or improving on previously taught hair styling techniques in order to overcome or compensate for the boring, lifeless look that results from the use of straight-edged scissors. For example, one means to overcome a blunt edge cut is to use a different type of cutting tool such as a straight bladed hair styling raizor, which creates a whole new hair style or a look that basically introduces variations into the final length of the hair strands relative to different sections along the head. A hair style that achieved a unique look by using a blade rather than scissors, was the “shag” haircut, which was very popular in the 1970's. The shag haircut was premised upon layering of the hair, which was not possible using a scissors cut. Thus, it can be appreciated that in their quests for creating a new look to the hair, stylists are rather limited to either discovering newer cutting methodologies or they are experimenting with using new types of hair cutting tools which improve the blunt cut effect of straight-edged scissors.

As an alternative means for introducing variations in the final length of the hair after it is cut, some hairstylists have attempted to modify the tools that have been used for years as a means to accomplish a new hair style or look. For example, in U.S. Pat. No. 6,385,851, to Yey, several prior art hair stylist scissor designs are disclosed, along with the new design that inventor Yeh has proposed. The prior art hairdressing scissors disclosed therein were scissor designs that cut the hair in sections, meaning the hair in between the cutting teeth would be left uncut. Inventor Yeh attempts to overcome that problem by introducing a blade design that is said to overcome those shortfalls by cutting hair more in a continuum and along several points. However, his blade design is overly complicated in that each blade element incorporates a plurality of teeth that contain several guide faces and sloping surfaces, which unfortunately restricts cutting so that only a very small amount of hair that is introduced between the blades is cut at a different length than the remainder of hair that is entrapped in between the blades. Thus, his blade design minimally overcomes the blunt-edged cut of conventional scissor designs.

In another patent issued to Yeh, namely U.S. Pat. No. 6,557,263, another type of hair cutting tool is introduced. The concept of this design is to connectively join a plurality of identical hair cutting scissors in order to accomplish a simultaneous series of point cuts as a means of achieving a different look. Point cutting of the hair is a hairstyling technique where the stylist concentrates each cut at the very ends of the hair strand, whereby only a small portion of hair is cut or snipped on one given closing of the scissors. In order to achieve a desired look, the stylist has to perform a series of point cuts around the periphery of the head. Thus, the concept of the Yeh '263 patent is to stack the scissors in order to reduce the number of point cuts that would have normally been required to achieve the same end result. In a second embodiment, the scissors are stacked in such a way that the tip ends are not in alignment. With that embodiment, the hair can be cut or thinned to form a “good-looking” hairstyle. Although this new tool provides another means for introducing variations into the final cut length of the hair, it has its obvious limitations. For instance, hair dressing scissors are precision instruments that are very expensive. Therefore, this design is cost prohibitive because several scissors must be stacked together in order to achieve a certain look. Furthermore, when several scissors are stacked together, the assembly becomes more and more difficult to use, especially as each additional scissor unit is added to the assemblage. Finally, when several scissors are simultaneously and continuously used, the sharpening costs likewise increases, thereby adding to an expense that stylists would like to avoid.

Based on the above-mentioned problems, there still exists a heartfelt need to provide a new type of hairdressing tool that solves the problem's and deficiencies existing in the hair styling industry. With that in mind, the present invention overcomes the shortfalls mentioned above by providing a unique and new hairstyling tool that is constructed for a pair of hair dressing scissors, whereby the blades, or scissor elements are provided with a series of non-uniform teeth that cut the hair at various points, rather than along a single, continuous edge. The resultant effect is that the hair is cut with varying lengths, such that the longer hairs can laterally move underneath the shorter lengths of hair, thereby giving the hair more movement and hence a more lived-in look.

### SUMMARY OF THE INVENTION

It is the primary object of the present invention to provide an improved pair of hairdressing scissors for point cutting the hair entrapped between the blades in order to overcome the continuous, blunt end cut provide by conventional scissors. The object is met in the present invention with scissors that comprise a first and a second scissors element pivotally connected together, wherein each of said elements have an end with a tip and an end with a handle and a blade portion disposed therebetween. Each of said blade portions includes an identical plurality of spaced teeth, where said teeth on each blade portion alternate between a tall tooth and a short tooth. The teeth on said first element are complementarily meshed between said teeth on said second element when said elements are in a closed and cutting position. With the scissors of the present invention, hair to be cut is introduced between said elements and the hair is then cut at various points along the scissors elements such that alternating short and long lengths are accomplished, the length variations corresponding to the tall and short teeth of said blade portions. The teeth generally have a pyramidal shape comprising a base, a first side and a second side, wherein said base of each tooth includes a proximate and a distal end, wherein the distal end of the base of each short tooth is juxtaposed with the proximate end of the base of each tall tooth and the proximate end of the base of each short tooth is juxtaposed with the distal end of the base of each tall tooth. In one embodiment, the first side of all teeth include a first and a second beveled cutting surface, wherein the beveled surfaces extend upwardly from the base to an apex of said tooth, and in another embodiment, the beveled surfaces have identical extents.

The features and advantages of the invention will be further understood upon consideration of the following detailed description of an embodiment of the invention taken in conjunction with the drawings, in which:

### BRIEF DESCRIPTION OF THE DRAWINGS

FIG. 1 is an elevational view of a preferred embodiment of a pair of hairdressing scissors in accordance with the invention in a closed position.

FIG. 2 is an elevational view of the pair of scissors shown in FIG. 1 in an open position.

FIG. 3 is a top view of the preferred embodiment of a pair of hairdressing scissors in accordance with the present invention.

FIG. 4A is a side view of one of the scissor elements that form the scissors in accordance with the present invention shown in FIG. 3.

FIG. 4B is a top view of the scissor element shown in FIG. 4A.

FIG. 5A is a side view of the other scissor element that forms the scissors in accordance with the present invention shown in FIG. 3.

FIG. 5B is a top view of the scissors element shown in FIG. 5A.

FIG. 6 is an enlarged top view of a portion of the scissors element shown in FIG. 5A.

FIG. 7 is a top view of a second embodiment of a pair of hairdressing scissors in accordance with the present invention.

### DETAILED DESCRIPTION OF A PREFERRED EMBODIMENT

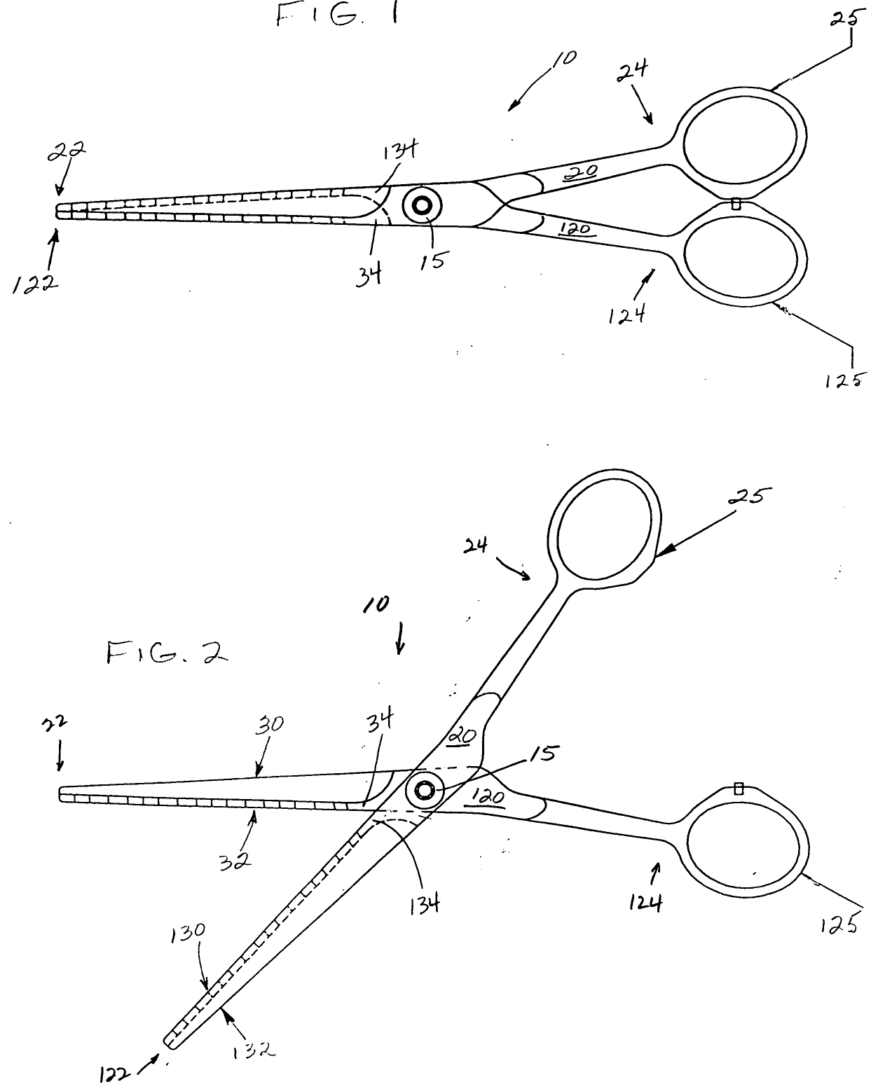

Referring to FIGS. 1-6, a first and preferred embodiment of a pair of hairdressing scissors 10 in accordance with the present invention are shown and are seen to include two scissor elements 20 and 120 pivotally connected together by a pivot 15. Each element 20,120 has a respective first end 22,122 that terminates with a tip, and a second, base end 24,124. Each element also has a respective leading edge 26,126, trailing edge 28,128, an upper end 30,130, and a lower end 32,132. Immediately adjacent each base end 24,124 is a respective handle 25,125. Although it is incorporated into the construction of each of the scissor elements, yet not detected in the top view of the drawing figures, it is important to understand that when the shears are in the closed position, there is a slight inward curvature of the elements 20,120, toward each other along the longitudinal extent of the elements from the pivot 15 to the tips 22,122 in order to promote a grinding of the shearing surfaces of the scissors in order to promote cutting of the hair that is entrapped between the scissors elements 20,120. For all practical purposes, the scissors elements 20,120, will have identical lengths, widths, and heights, unless dimensional differences of specific components are identified later herein.

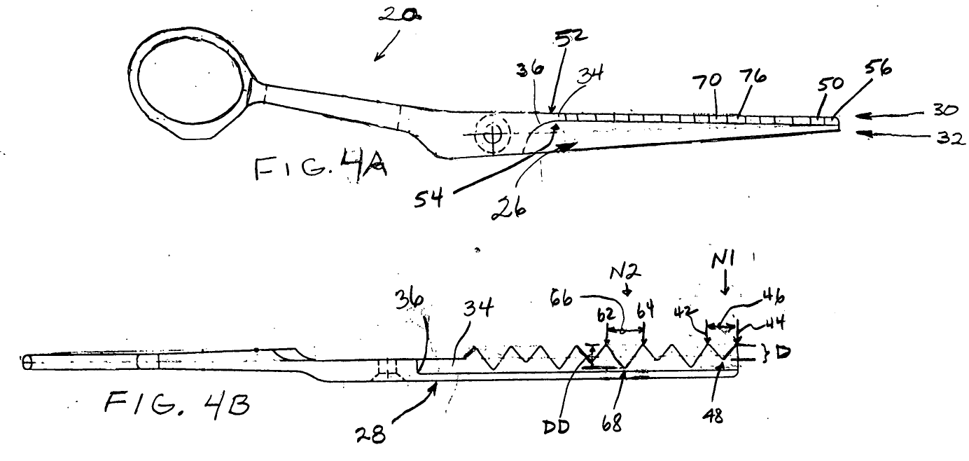

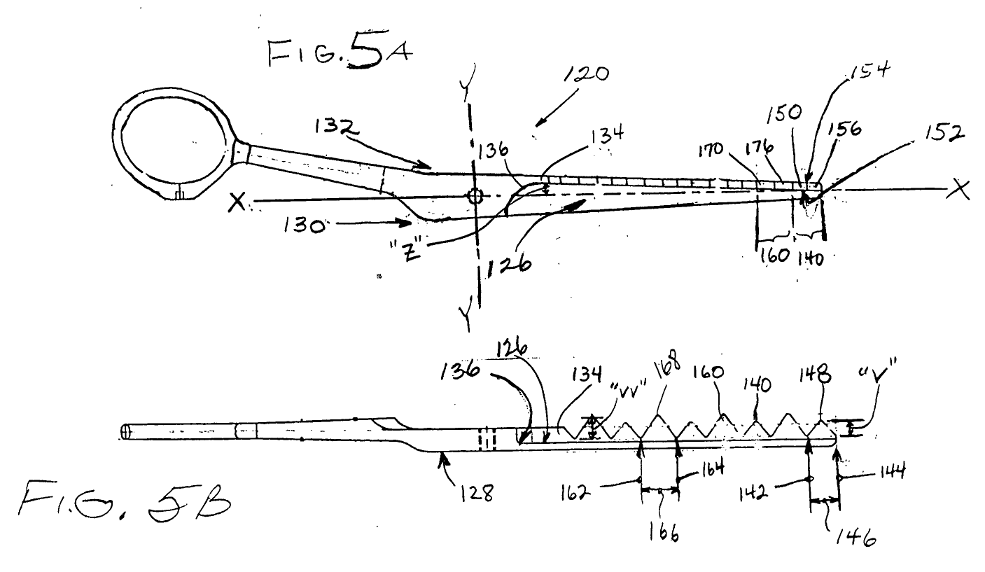

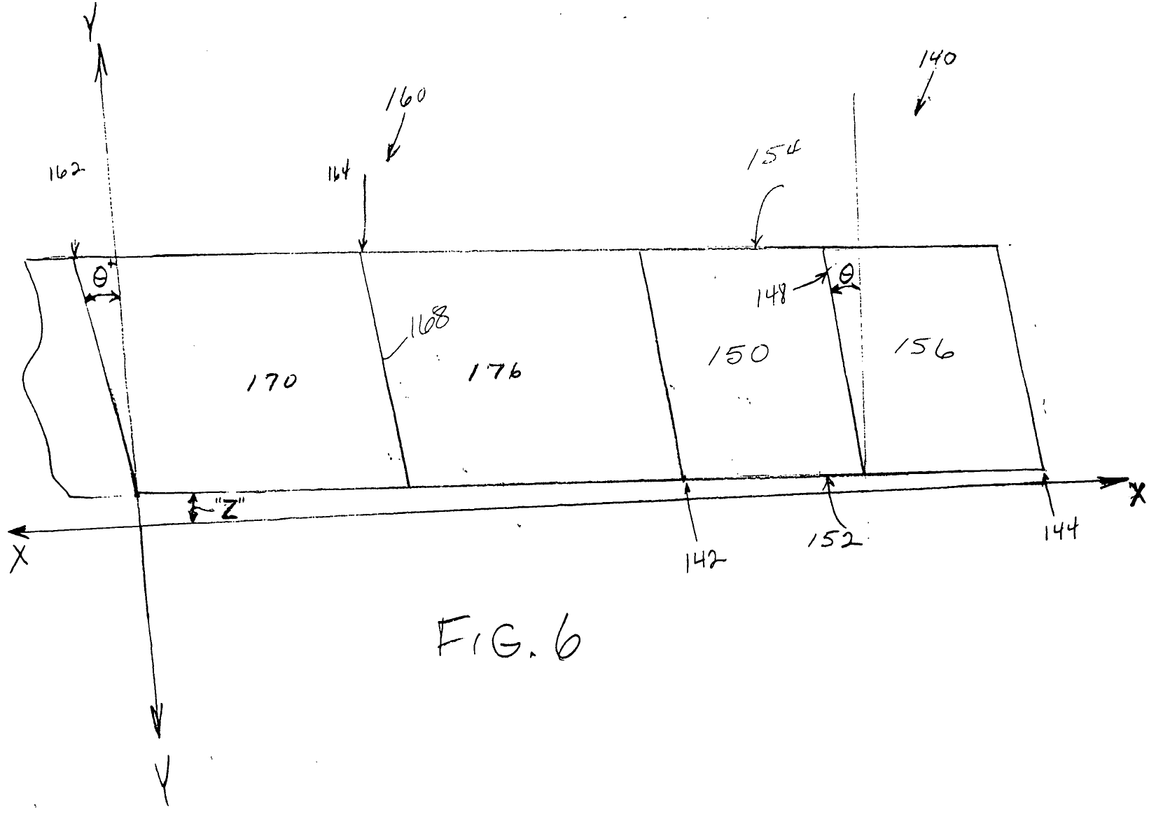

The scissor elements 20,120 that are shown for purposes of illustrating this invention are formed with respective and identical transverse flanges 34,134, projecting from each respective scissor element. As best seen in FIGS. 4A and 4B, the transverse flange 34 of element 20 is located along leading edge 26 and is disposed at the upper end 30 of the element. Transverse flange 34 extends from first end 22, towards second end 24, terminating with rounded edge 36. The transverse flange 134 is best seen when viewing FIGS. 5A and 5B. There, it is seen that the transverse flange 134 on element 120 is also located along the leading edge 126. However, flange 134 is disposed at the lower end 132 of that scissors element, and it extends from first end 122, towards second end 124, terminating with rounded edge 136. It is important to keep in mind that although the scissors element 120 shown in FIG. 5A features the handle 125 pointing towards the top of the page, the element 120 is actually shown upside down for the sake of more easily describing the components. Thus, the transverse flange is actually formed on the lower end 132 of the scissors element, even though the illustration makes it appear at the top.

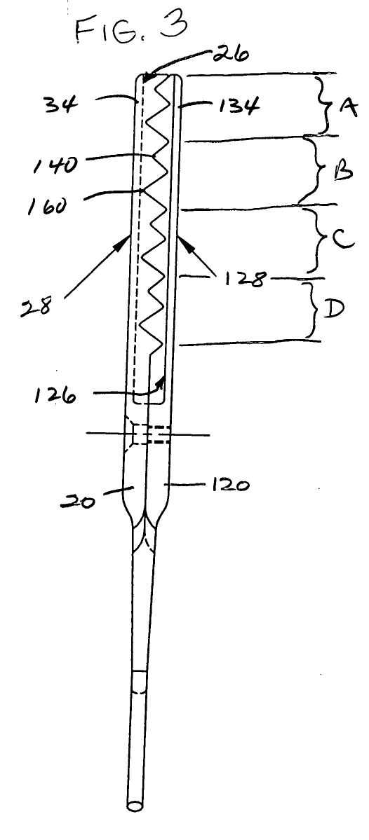

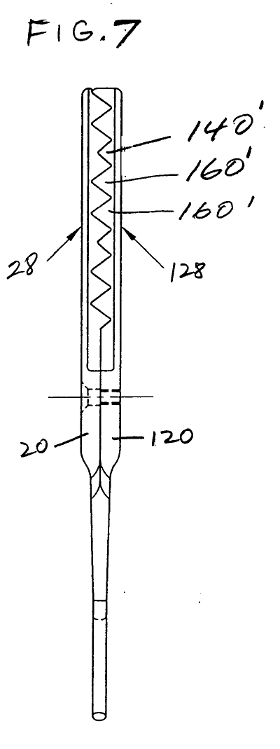

Referring specifically to FIG. 3, it is seen that transverse flange 134 is provided with a series of two types of teeth, 140 and 160, which generally have a pyramidal configuration. Only two sets of short/tall teeth have been identified with reference numbers; the remainder of the teeth sets would be similarly identified. The transverse flange 34, on the other hand, is provided with a series of notches N1 and N2, in which the teeth 140 and 160 complementarily fit within and they will be described in greater detail later herein. Now turning again to FIG. 5B, it is seen that the teeth identified at 140, are relatively shorter in vertical extent compared to the teeth identified at 160. Therefore, teeth 140 will hereinafter be referred to as the “short” teeth, while teeth 160 will hereinafter be referred to as the “tall” teeth. The tall teeth are about twice the vertical height of the short teeth. In FIG. 5A, it should be understood that the teeth 140 and 160 are seen coming out of the plane of the paper. As FIG. 5B shows, not all of the short teeth 140 are disposed in ajuxtaposed relationship to each other. In fact, a specific pattern is established between the short teeth and the long teeth for purposes of the invention. Starting from the tip end 122, and moving towards the rounded edge 136, it is seen that the pattern of teeth is as follows: one short tooth 140, followed by one tall tooth 160, with the pattern repeating itself such that four short/tall teeth sets are formed. That pattern will produce a unique and desired point cutting of the hair, with a lived-in effect, as will be explained later herein. In a second embodiment of the invention, shown in FIG. 7, the teeth pattern is as follows: two short teeth 140′, followed by two tall teeth 160′. Other than the change in teeth pattern, the second embodiment is identical in all other respects as will be described for the preferred embodiment. Again referencing FIG. 5B, it is seen that each short tooth 140 will have an identical longitudinal extent that is defined as the distance between proximate tooth end 142 and distal tooth end 144. Because the ends 142 and 144 are located on the same horizontal plane, they actually define the outermost longitudinal limits of a base 146 of each tooth 140. Each short tooth 140 will also have an identical vertical extent “V” that is defined as the distance between base 146 and apex 148. Referring now to FIG. 5A, each short tooth 140 is further comprised of a front shearing face 150 and a rear shearing face 156. The front shearing face 150 is defined as the area extending from proximate end 142, upwardly to apex 48, further extending between upper surface 152 and lower surface 154. The rear shearing face 156 is defined as the area extending from distal end 144, upwardly to apex 148, further extending between upper surface 152 and lower surface 154. As FIG. 5A shows, transverse flange 134 slopes in a downwardly fashion from second end 124, toward the first end 122, with the upper surface 152 and lower surface 154 being parallel to each other. However, as best seen and emphasized in FIG. 6, the front and rear shearing faces 150 and 156, are not cut at right angles to either of the surfaces 152 or 154. There, it is seen that an X-Y axis grid is referenced with respect to one tooth set (Set B) of the short/tall teeth 140,160. In FIG. 6, the X axis of this grid is in the same location as seen in FIG. 5A. In the enlargement of the teeth 140,160 in FIG. 6, it can be appreciated that each respective apex 148 on each of the short teeth 140 will be vertically displaced from the Y-axis by the angle θ, meaning that surfaces 150 and 156, will be oblique surfaces that are angularly displaced less than 90° from the Y axis. The same will be true for the tall teeth, as will be explained later within.

Like the short teeth, all of the tall teeth on scissors element 120 are identical, therefore, only one of the tall teeth 160 will be described in greater detail. The desired pattern mentioned above with respect to the preferred embodiment of the invention, means that the tall teeth 160 will be in a juxtaposed relationship to each other either. Nevertheless, each tall tooth 160 will have an identical longitudinal extent that is defined as the distance between proximate tooth end 162 and distal tooth end 164. Because ends 162 and 164 are located on a same horizontal plane, the ends 162,164 will actually define the longitudinal limits of a base 166 of each tall tooth 160. It should be evident that the horizontal plane which the ends 162,164 lie upon, is not the same horizontal plane that the ends 142,144 lie upon. Each tall tooth 160 will also have an identical vertical extent “VV” that is defined as the distance between base 166 and apex 168. Each tall tooth 160 is further comprised of a front shearing face 170 and a rear shearing face 176. The front shearing face 170 is defined as the area extending from proximate end 162, upwardly to apex 168, further extending between upper surface 152 and lower surface 154. The rear shearing face 176 is defined as the area extending from distal end 164,-upwardly to apex 168, further extending between upper surface 152 and lower surface 154. As with the short teeth, the front and rear shearing faces 170 and 174 of the tall teeth are not cut at right angles to either of the parallel surfaces 152 or 154, causing them to be oblique surfaces of an angle that is less than 90° from the Y axis. In FIG. 6, another X-Y axis grid is referenced with respect to tooth 160, and once again, it is seen that apex 168 is vertically displaced from the Y-axis, this time by the angle θ+. Thus, the front shearing face 170 formed on tooth 160 of tooth set B, will be parallel to the rear shearing face 176 formed on this same tall tooth of set B.

In FIG. 5A, it is seen that as one moves from the front end 122, to the back end 124 of scissor element 120, the distance from the reference line X-X, to upper surface 152, which is identified as “Z,” will increase. This correspondingly means that as the distance “Z” increases, the angle θ will also increase such that the angular displacement of the shearing faces of the small tooth in a particular tooth set, will be relatively smaller than the angular displacement θ+ of the shearing faces of the tall tooth in that same tooth set. Thus, it should be clear that the tooth set A (teeth 140,160 on tip end 122) will have the smallest angular displacements θ and θ+ from the Y-axis; tooth set B will have larger angular displacements relative to set A; tooth set C will be relatively larger than set B; and set D will have the largest. The differing angles θ and θ+ for each respective tooth set means that the obliqueness or angularity of the respective shearing faces decreases rather dramatically between the teeth at the back of scissors compared to the teeth at the tip of the scissors. Finally, it should also be clear from viewing FIGS. 5B and 6, that the horizontal extent of base 146 (the distance between the proximate end 142 and distal end 144) is relatively smaller than that same extent of base 166 of the tall teeth.

Turning attention now to FIG. 4A, the transverse flange 34 will now be described in more detail. Instead of being provided with teeth, flange 34 is provided with a series of notches N1 and N2. The notches are complementary to the teeth 140 and 160 on flange 134 of scissors element 120 when the scissors elements are closed, as in FIG. 3. The first notch is identified at N1, is relatively shallower in vertical depth of the illustration, compared to the notch N2. Therefore, all of the notches labeled N1 will hereinafter be referred to as the “shallow” notches, while notches N2 will hereinafter be referred to as the “deep” notches. In FIG. 4A, it should be understood that the notches N1 and N2 will be seen extending into the plane of the paper. As FIG. 4B shows, not all of the shallow notches N1 are disposed in ajuxtaposed relationship to each other. In fact, a specific pattern is established between the shallow notches and the deep notches for purposes of the invention. Starting from the tip end 22, and moving towards the rounded edge 36, it is seen that the pattern of notches is as follows: one shallow notch N1, followed by one deep notch N2, with the pattern repeating itself such that four shallow/deep notch sets are formed. That pattern corresponds to the same short and tall tooth pattern on element 120, and collectively, the complementary patterns on each of the elements 20,120, will produce the unique and desired point cutting of the hair, as will be explained shortly herein. In the second embodiment of the invention, shown in FIG. 7, the pattern of notches is as follows: two shallow notches N1′, followed by two deep notches N2′. Returning again to FIG. 4B, it is seen that each of the shallow notches N1 will be formed across the thickness of flange 34, which extends into the plane of the paper, and each will have a longitudinal span or extent 46 that is defined as the distance between proximate peak 42 and distal peak 44 since each of the peaks 42 and 44 are located on the same horizontal plane. Each shallow notch N1 will also have an identical vertical depth “D.” That depth is defined as the vertical distance between shallow valley 48 and either of the peaks 42,44, since they are both on the same plane. Referring now to FIG. 4A, once each shallow notch N1 is cut into flange 34, a front surface 50 and a rear surface 56 are formed. The front surface 50 is defined as the area extending from valley shallow 48, upwardly to distal peak 44, extending between upper surface 52 and lower surface 54, which define the thickness of flange 34. The rear surface 56 is defined as the area extending from shallow valley 48, upwardly to proximate peak 42, extending between upper surface 52 and lower surface 54. In FIG. 4A, it is seen that transverse flange 34 slopes in a downwardly fashion from second end 24, toward the first end 22, with the upper surface 52 and lower surface 54 being parallel to each other. Like the front and rear shearing faces 150,156 on flange 134, the front and rear surfaces 50 and 56 that are formed after each notch N1 is cut, do not form surfaces that are at right angles to either of the surfaces 52 or 54. In fact, the front and rear surfaces 50,56, will display an oblique angularity that respectively matches or rather is complementary to the oblique angularity of the shearing faces 150,156, within each respective tooth set A,B,C,D. This necessarily means that each short tooth 140 on transverse flange 134 will complementarily mesh within the span 46 of each corresponding shallow notch N1 such that shearing faces 150,156, will frictionally engage the front and rear surfaces 50,56 during the closing of the two scissors elements so as to cut the hair.

As mentioned above with the shallow notches, since all of the deep notches N2 on scissors element 20 are identical, only one of the deep notches N2 will be described in greater detail. Because of the desired short and tall tooth pattern with respect to the preferred embodiment of the invention, the deep notches N2 will not be disposed in a juxtaposed relationship to each other. However, each deep notch N2 will span an identical longitudinal extent that is defined as the distance between proximate peak 62 and distal peak 64since peaks 62 and 64 are located on the same horizontal plane. Each deep notch N2 will also have an identical vertical depth “DD.” That depth is defined as the vertical distance between deep valley 68 and either of the peaks 62,64, since both peaks are on the same plane. Referring now to FIG. 4A, once each deep notch N2 is cut into flange 34, a front surface 70 and a rear surface 76 are formed. The front surface 70 is defined as the area extending from deep valley 68, upwardly to distal peak 64, extending between upper surface 52 and lower surface 54 of flange 34, which defines the thickness of the flange. The rear surface 76 is defined as the area extending from deep valley 68, upwardly to proximate peak 62, extending between upper surface 52 and lower surface 54. As a result of the downwardly sloping flange 34, the front and rear surfaces 70,76 that are formed after each notch N2 is cut, do not form surfaces that are at right angles to either of the surfaces 52 or 54. Similar to the shallow notches, the front and rear surfaces 70,76, will display an oblique angularity that respectively matches or rather is complementary to the oblique angularity of the shearing faces 160,166, within each respective tooth set A,B,C,D on element 120. This necessarily means that each tall tooth 160 on transverse flange 134 will complementarily mesh within the span 66 of each corresponding deep notch N1 such that shearing faces 160,166, will frictionally engage the front and rear surfaces 70,76 during the closing of the two scissors elements so as to cut the hair. Finally, it should also be understood that the horizontal span of the deep notches N2 is relatively larger than the span of notches N1.

When the scissors of the present invention are in operation or use, the short teeth 140 on scissors element 120, complementarily mesh and pass through the shallow notches N1 of scissors element 20 as the elements are closed during use. Likewise, tall teeth 160 complementarily mesh and pass through the deep notches N2 of scissors element 20. The slight curvature in each of the scissor elements 20,120, as well as the downward sloping transverse flanges 34,134, causes a slight frictional engagement between the respective sets of the front and rear shearing faces 150,156 and 160,166, of the short and tall teeth against the respective front and rear surfaces 50,56, and 60,66 of the notches such that any strands of hair that are entrapped between the tip and base of the scissors elements will be cut at the shearing faces which correspond with the respective short or tall teeth. This means that the hair, once cut, will have variations in its length that are not possible with conventional hairdressing scissors. The variations in hair length will directly correspond to the locations of the shearing faces on each of the respective sets of short and tall teeth 140,160, thereby creating a series of point cuts instead of one continuous blunt edge cut. The final result achieved with the scissors of the present invention is that the hair will now have a series of natural, jagged edges that corresponds to varying lengths of hair. By cutting the hair in this fashion, the hair will have more “movement” and texture, thereby giving it a more lived-in look. The movement created by the scissors of the present invention is caused by the very tail ends of the longer lengths of hair having the ability to laterally move underneath the ends of the shorter lengths of hair. In other words, the newly induced variations in hair length break up what used to be a continuous, line of hair cut at only one continuous length. To make the movement of the hair ever more pronounced, the scissors can be provided with a tooth pattern like that shown in FIG. 7, where the pattern is two tall teeth followed by two short teeth. In this way, the number of short-lengthened hairs in a continuum will be increased, meaning that the longer lengths of hair will have even more room to laterally move underneath the shorter lengths of hair.

While the apparatus described herein form a preferred embodiment of this invention, it will be understood that this invention is not so limited, and changes can be made without departing from the scope and spirit of this invention, which is defined in the appended claims.

1. A pair of hairdressing scissors for styling and cutting hair, comprising:
a first and a second scissor element pivotally connected together, each scissor element including a respective transversely extending flange and each scissor element having a first end with a tip and a second end with a handle, said transverse flange on said first scissor element having a plurality of teeth formed thereon, said teeth alternating between a tall tooth and a short tooth, said transverse flange on said second scissor element having a plurality of notches formed therein, said notches alternating between a shallow and a deep notch, wherein said notches are complementarily meshed between said teeth on said first scissor element when both of said scissors elements are in a closed and cutting position, said short and tall teeth including respective faces and said shallow and deep notches including respective surfaces, wherein said faces and surfaces have complementary angularities for shearing the hair such that when a plurality of hair strands to be cut are introduced between said scissor elements, the hair strands are resultantly cut at alternating tall and short lengths, whereby the longer lengths of hair laterally move respective to the shorter lengths of hair, thereby producing a hair style with movement.

2. The hairdressing scissors of claim 1, wherein all teeth generally have a pyramidal configuration.

3. The hairdressing scissors of claim 1, wherein each of the short and tall teeth have a respective base, said base of each tooth defined as the longitudinal distance between a proximate tooth end and a distal tooth end.

4. The hairdressing scissors of claim 3, wherein on said first scissors element, the distal end of the base of each short tooth is juxtaposed with the proximate end of the base of each tall tooth.

5. The hairdressing scissors of claim 3, wherein all of said teeth include a front and a rear shearing face, wherein said front shearing face is defined as an area extending from said proximate end, upwardly to an apex, and further extending between an upper surface and a lower surface of said scissors element.

6. The hairdressing scissors of claim 3, wherein said rear shearing face is defined as an area extending from said distal end, upwardly to an apex, and further extending between an upper surface and a lower surface of said scissors element.

7. The hairdressing scissors of claim 5, wherein said front shearing face and said rear shearing face on a particular tooth are parallel to each other.

8. The hairdressing scissors of claim 3, wherein all of said shallow and deep notches will have a respective longitudinal span that is defined as a distance between a respective proximate and a distal peak, wherein all of said peaks are located on a same horizontal plane.

9. The hairdressing scissors of claim 8, wherein each shallow notch has an identical depth, said depth defined as a vertical distance between a shallow valley and one of said proximate and distal peaks.

10. The hairdressing scissors of claim 9, wherein each shallow notch is delimited by a front surface and a rear surface, said front surface defined as an area extending from said shallow valley, upwardly to said distal peak, and further extending between an upper surface and a lower surface which defines a thickness of said flange of said scissors element, and wherein said rear surface is defined as an area extending from said shallow valley, upwardly to said proximate peak, and further extending between said upper and lower surfaces which define said thickness of said flange of said scissors element.

11. The hairdressing scissors of claim 8, wherein each deep notch has an identical depth, said depth defined as a vertical distance between a deep valley and one of said proximate and distal peaks.

12. The hairdressing scissors of claim 9, wherein each deep notch is delimited by a front surface and a rear surface, said front surface defined as an area extending from said deep valley, upwardly to said distal peak, and further extending between an upper surface and a lower surface which defines a thickness of said flange of said scissors element, and wherein said rear surface is defined as an area extending from said deep valley, upwardly to said proximate peak, and further extending between said upper and lower surfaces which define said thickness of said flange of said scissors element.

13. The hairdressing scissors of claim 3, wherein on said first scissors element, the short and the tall teeth are arranged such that two short teeth are juxtaposed next to each other and two tall teeth are juxtaposed next to each other, wherein a pattern of two short teeth are followed by two tall teeth is established along the length of the flange.
